(19) United States
(12) Patent Application Publication
(10) Pub. No.: US 2018/0114473 A1
(43) Pub. Date: Apr. 26, 2018

(54) AUTOMOBILE PLACARD SYSTEMS AND METHOD

(71) Applicant: Cynthia Chomicki, Minot, ND (US)

(72) Inventor: Cynthia Chomicki, Minot, ND (US)

(21) Appl. No.: 15/498,332

(22) Filed: Apr. 26, 2017

Related U.S. Application Data
(63) Continuation-in-part of application No. 15/331,574, filed on Oct. 21, 2016, now abandoned.

(51) Int. Cl. G09F 21/04; G09F 3/02; G09F 7/18

(52) U.S. Cl. CPC G09F 21/04; G09F 2007/1865; G09F 7/18; G09F 3/02

(57) ABSTRACT

An automobile placard system for providing vehicle-specific information. An automobile placard system. The placard may have a front side, a back side, a substantially rectangular perimeter, and an automobile-mirror-hanger-hook. The placard may be at least partially made of flexible durable plastic suitable for extended periods of UV exposure. The front side may include permanent indicia that guides a user to add variable information, and includes an erasable surface. The backside may also be configured to be eraseably written on with alterable information.

### CROSS-REFERENCE TO RELATED APPLICATION(S)

The present application is a continuation-in-part and related to and claims priority to Pending U.S. patent application Ser. No. 15/331,574 filed Oct. 21, 2016, which is incorporated by reference herein in its entirety.

### BACKGROUND OF THE INVENTION

The following includes information that may be useful in understanding the present disclosures. It is not an admission that any of the information provided herein is prior art, or material, to the presently described or claimed inventions, or that any publication or document that is specifically or implicitly referenced is prior art.

### 1. Field of the Invention

The present disclosure relates generally to the field of visual communications and more specifically relates to an automobile signage devices.

### 2. Description of Related Art

Hanging tags are commonly used to identify vehicles that are for sale at a car dealership. The hanging tag may be hung from the rear-view mirror, and typically includes identifying information about the vehicle for sale such as a vehicle identification number and sale price. Hanging tags are typically made of a paper-type of material. Paper-type material hanging tags are not suitable for multiple uses for more than one vehicle, because each vehicle has a unique identifier and price. In addition, if an error is made when adding the automobile's identification information and price to the paper-type material hanging tag, the tag must be discarded. Further, most paper-type material hanging tags are not consistent in communicating the correct information to potential customers. A need therefore exists for an improved mirror hanging tag system to address the deficiencies of prior art for automobile hanging tags. A suitable solution is desired.

Several attempts have been made to solve the above-mentioned problems such as those found in U.S. patent and U.S. Publication numbers: U.S. Pat. No. 8,424,915 to Haag; U.S. Pat. No. 7,293,384 to Lewis; U.S. Pat. No. 8,220,188 to Keller; U.S. Pat. No. 6,564,981 to Murphy; and 2015/0097388 to Bosco. This art is representative of vehicle-specific information. However, none of the above references, taken either singly or in combination, is seen to describe the invention as claimed.

### BRIEF SUMMARY OF THE INVENTION

In view of the foregoing disadvantages inherent in the known car dealer hanging tags art, the present disclosure provides a novel automobile placard system. The general purpose of the present disclosure, which will be described subsequently in greater detail is to provide vehicle-specific information.

An automobile placard system is disclosed for displaying information on an automobile is disclosed in a preferred embodiment including an automobile placard for displaying information. The placard may include a front side, a back side, a substantially rectangular perimeter, and an automobile-mirror-hanger-hook. The placard is configured to be between 1 mm and 5 mm to be easily grasped by the user to aid in installation on a mirror-mount-stem of an automobile interior rear view mirror. The placard is at least partially made of flexible durable plastic, suitable for extended periods of UV exposure. Further, the placard is at least partially made of fade-resistant colored materials suitable for an environment with extended periods of UV exposure.

The front side may include “fields” or indicium printed with permanent indicia that guides a user to add variable information, and further includes an erasable surface adapted to be repeatedly written on and erased. The permanent indicia includes a description of a type of variable information, and further includes a set location on the front side of the automobile placard for the variable information to be added. The permanent indicia further guides the user to add variable information to the front side of the automobile placard. The erasable surface is configured to be eraseably written on by an erasable marker. The backside is also configured to be eraseably written on with alterable information. The substantially rectangular perimeter may have a bottom end and a top end, with the top end having two rounded corners. The automobile-mirror-hanger-hook may have a flip-latch. The flip latch may include an open configuration and closed configuration. The latch system is attached to the actual tag by design. The tag itself is preferably made out of a durable erasable board. It may comprise a rubber like material for flexibility, just on the top portion of the tag. The function of the latch system is to keep the tag from ripping, tearing, also for easy removal and placement. A logo or titles can be written permanently through the manufacturer on a dry eraser type board. The latch works so that if the user pushes on it, it opens and when he/she pulls to take it down it will open. It is preferably circular in shape and comprises an opening that opens and closes in a similar fashion to a doggie door. The preferred material that is used is rubbery plastic so is designed and attached to the eraser board.

The information is written on the tag with a dry eraser marker (erasable) such that the information can be erased with a cloth that the user would like to include with the order. Other possible shapes may comprise circle rectangular.

The automobile-mirror-hanger-hook is configured to be removably-coupleable with a mirror-mount-stem of an automobile interior rear view mirror via flexing into an open configuration when placing the automobile placard about the mirror-mount-stem. The automobile-mirror-hanger-hook includes an arcuate bend. The automobile-mirror-hanger-hook is configured to be removably-coupleable with a mirror-mount-stem of an automobile interior rear view mirror. The flip-latch of the automobile-mirror-hanger-hook is configured to unlatch into an open configuration when placing the automobile placard about the mirror-mount-stem. The flip-latch of the automobile-mirror-hanger-hook is further configured latch on to the mirror-mount-stem when in the closed configuration. The automobile-mirror-hanger-hook is at least partially made of durable plastic suitable for extended periods of UV exposure.

The automobile placard system further may further include a set of instructions and wherein the placard and the set of instructions are arranged as a kit.

A method of using the automobile placard system may include the steps of: adding variable information to the front side of an automobile placard using the permanent indicia as a guide, opening the automobile-mirror-hangar-hook, coupling the automobile-mirror-hangar-hook with a mirror-mount-stem of an automobile interior rear view mirror, closing the automobile-mirror-hangar-hook, removing the automobile placard when display is no longer desired, and erasing the variable information when the variable information is no longer desired.

The present disclosure holds significant improvements and serves as a method to provide vehicle-specific information. For purposes of summarizing the invention, certain aspects, advantages, and novel features of the disclosure have been described herein. It is to be understood that not necessarily all such advantages may be achieved in accordance with any one particular embodiment of the disclosure. Thus, the disclosure may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate embodiments and methods of use for the present disclosure, automobile placard systems, constructed and operative according to the teachings of the present disclosure.

FIG. 1 is a front view, illustrating an automobile placard system during an ‘in-use’ condition, and showing a user attaching an automobile placard to the mirror-mount-stem of an automobile interior rear view mirror, according to an embodiment of the present disclosure.

FIG. 2 is another front view illustrating the automobile placard disclosure of FIG. 1, according to an embodiment of the present disclosure.

FIG. 3 is a front perspective view, illustrating an attachment means of the automobile placard, according to an embodiment of the present disclosure.

FIG. 4 is a back view illustrating the automobile placard, according to an embodiment of the present disclosure.

The various embodiments of the present disclosure will hereinafter be described in conjunction with the appended drawings, wherein like designations denote like elements.

### DETAILED DESCRIPTION

As discussed above, embodiments of the present disclosure relate to car dealer hanging tags, and more particularly to an automobile placard system as used to improve the display of vehicle-specific information. Preferably, the car dealer hanging tags provide vehicle-specific information and, yet operate reliably and are manufactured at a modest expense. Thus, the present disclosure address a presently unmet need existing for a reliable automobile placard system that can avoid the above-mentioned and other problems in the automotive sales industry.

Generally speaking, automobile placard systems may include a reusable price tag for vehicles for sale at a car dealership. The reusable price tag's function is to provide customers a viewable means of the price for a specific vehicle. The reusable tag may be hung from the rear view mirror for easy visibility. It can be used throughout the year and changed as the details for the vehicle change or if the tag is transferred to a new vehicle. The advantage to the reusable price tag is that it is durable, reusable, has improved presentation of information, and is versatile. The size of the reusable price tag may vary, but a 10″ by 10″ display surface may be preferred. It may be made of materials that are thin, bendable, erasable, and that do not discolor when exposed to the sun.

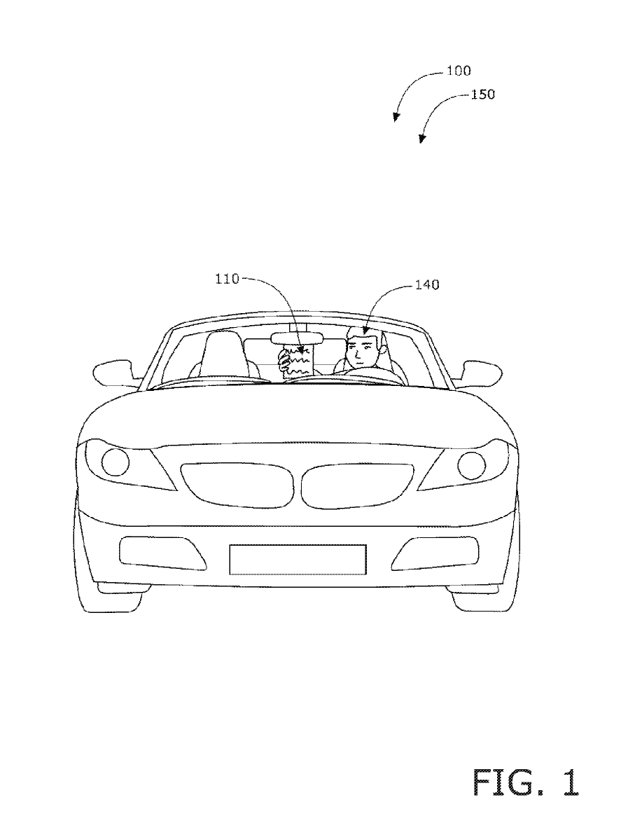

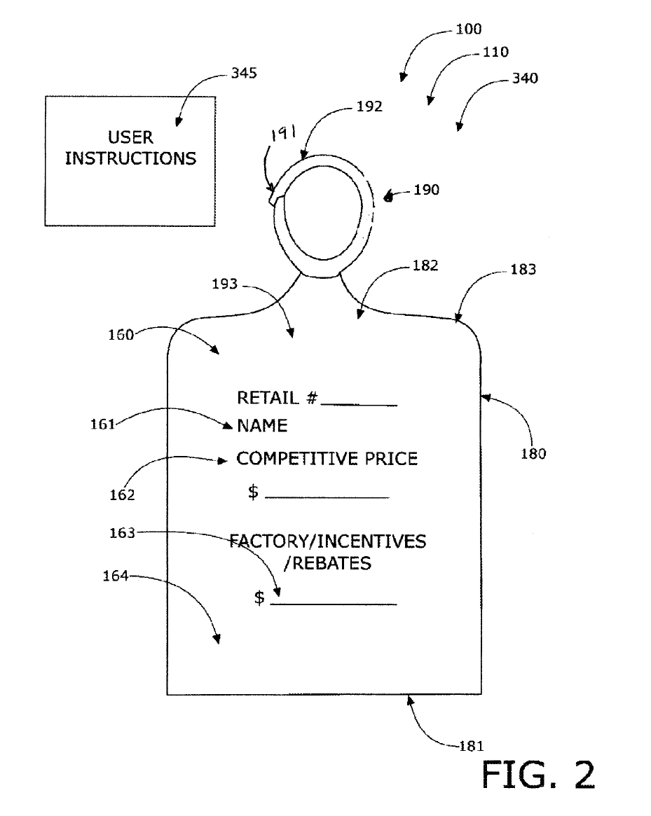

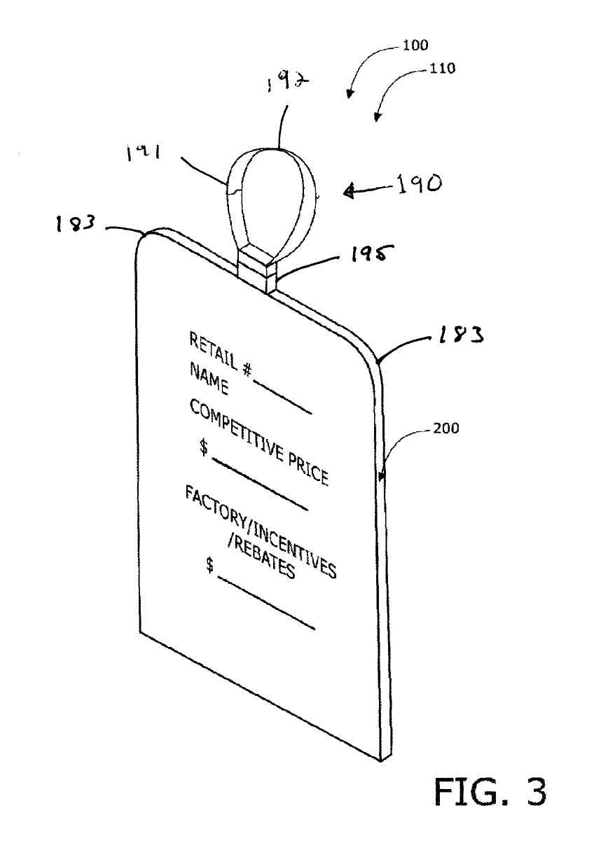

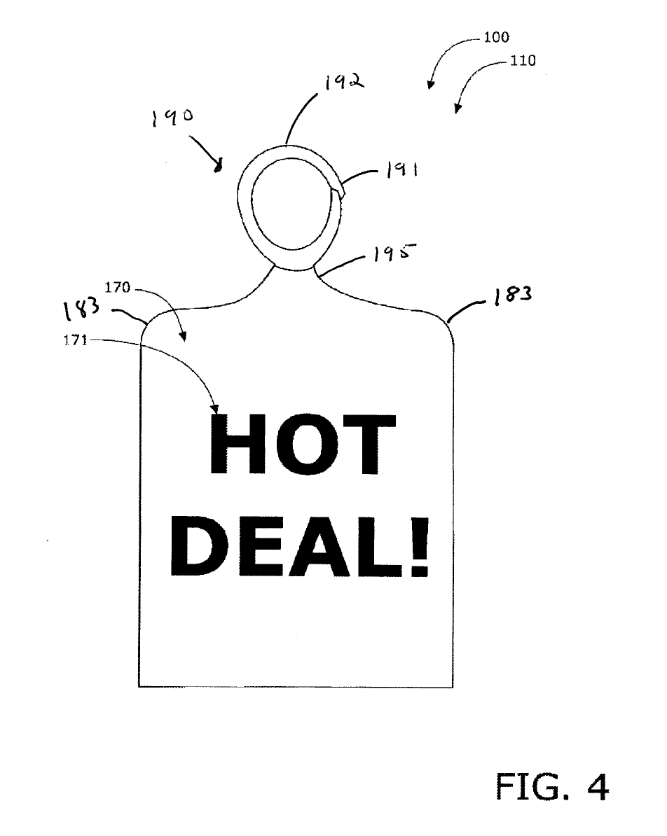

Referring to the drawings by numerals of reference there is shown in FIGS. 1-4, automobile placard system 100 in an “in use” condition 150, according to an embodiment of the present disclosure. Automobile placard 110 is configured to display information. Automobile placard 110 may include: a front side 160, a back side 170, a substantially rectangular perimeter 180, and an automobile-mirror-hanger-hook 190. It should be understood that terms such as front and back are used merely for convenience and ease of reference.

Front side 160 may include indicium 161 printed with permanent indicia 162 that describes one or more fillable fields” or otherwise guides user 140 to add variable information 163, and further includes erasable surface 164 adapted to be repeatedly written on and erased. Permanent indicia 162 guides user 140 to add variable information to front side 160 of automobile placard 110. In continuing to refer to front side 160, permanent indicia 162 includes a description of a type of variable information 163, and further includes a set location on front side 160 of automobile placard 110 for variable information 163 to be added. For example, the fields may address information such as an index or retail number, a price, and/or purchase incentives.

Erasable surface 164 may be configured to be eraseably written on by an erasable marker. In another embodiment of the present disclosure, erasable surface is configured to be eraseably written on by a grease pencil. In a further embodiment of the present disclosure, erasable surface is configured to be eraseably written on by a graphite pencil.

In further referring to automobile placard 110, automobile placard 110 may have a thickness 200 of or otherwise configured to be between 1 mm and 5 mm. In this way the automobile placard 110 may be easily grasped by user 140, aiding in installation on a mirror-mount-stem of an automobile interior rear view mirror. Placard 110 is at least partially made of flexible durable plastic 193 suitable for extended periods of UV exposure. Further, placard 110 is at least partially made of fade-resistant colored materials suitable for an environment with extended periods of UV exposure.

Back side 170 is structured to be eraseably written on with alterable information 171. Substantially rectangular perimeter 180 has bottom end 181 and top end 182. Further, top end 182 may include two rounded corners 183, or otherwise triggering recognition by a potential buyer of a “price tag” appearance.

In continuing to refer to automobile placard 110, automobile placard 110 may include automobile-mirror-hanger-hook 190 having flip-latch 191, with flip-latch 191 including an open configuration and closed configuration. Automobile-mirror-hanger-hook 190 may further include an arcuate bend 192 or the like.

Automobile-mirror-hanger-hook 190 may be configured to be removably-coupleable with a mirror-mount-stem of an automobile interior rear view mirror. In particular, the automobile-mirror-hanger-hook 190 may flex into an open configuration when placing automobile placard 110 about the mirror-mount-stem. Alternatively, flip-latch 191 of automobile-mirror-hanger-hook 190 may be configured to unlatch into an open configuration when placing automobile placard 110 about the mirror-mount-stem. Then the flip-latch 191 of automobile-mirror-hanger-hook 190 may be further configured to spring back, or otherwise latch on to the mirror-mount-stem, thus being in the closed configuration. Automobile-mirror-hanger-hook 190 may be at least partially made of durable plastic 193 suitable for extended periods of UV exposure.

It should be noted that automobile placard system 100 may be arranged as a kit 340 including the following parts: at least one automobile placard 110 and at least one set of user instructions 345. The kit 340 has instructions 345 such that functional relationships are detailed in relation to the structure of the automobile placard 110, such that it can be used, maintained, or the like in a preferred manner Automobile placard system 100 may be manufactured and configured in a wide variety of sizes and shapes for a wide assortment of applications.

Upon reading this specification, it should be appreciated that, under appropriate circumstances, considering such issues as design preference, user preferences, marketing preferences, cost, structural requirements, available materials, technological advances, etc., other automobile placard system arrangements or kit contents, such as, for example, including more or less components, customized parts, different color combinations, parts may be sold separately, etc., may be sufficient.

A method of use for automobile placard system 100 according to an embodiment of the present disclosure may include the steps of: step one, adding variable information 163 to a front side 160 of an automobile placard 110 using permanent indicia 162 as a guide; step two, opening an automobile-mirror-hangar-hook 190; step three, coupling the automobile-mirror-hangar-hook 190 with a mirror-mount-stem of an automobile interior rear view mirror; step four, closing the automobile-mirror-hangar-hook 190; step five, removing the automobile placard 110 when display is no longer desired; and step six, erasing the variable information 163 when the variable information is no longer desired.

It should be noted that the steps described in the method of use can be carried out in many different orders according to user preference. The use of “step of” should not be interpreted as “step for”, in the claims herein and is not intended to invoke the provisions of 35 U.S.C. § 112(f).

The embodiments of the disclosure described herein are exemplary and numerous. Modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. An automobile placard for displaying information, the automobile placard comprising:
a front side including an indicium printed with permanent indicia describing one or more fillable fields, and further including an erasable surface adapted to be repeatedly written on and erased;
a back side;
a substantially rectangular perimeter having a bottom end and a top end; and
an automobile-mirror-hanger-hook having a flip-latch with an open configuration and closed configuration.

2. The automobile placard of claim 1, wherein said automobile-mirror-hanger-hook is configured to be removably-coupleable with a mirror-mount-stem of an automobile interior rear view mirror by flexing into an open configuration when placing said automobile placard about said mirror-mount-stem.

3. The automobile placard of claim 1, wherein the top end attaches to the hanger hook by an elastomeric connection.

4. The automobile placard of claim 1, wherein said permanent indicia includes a description of a type of variable information, and further includes a set location on the front side of the automobile placard for said variable information to be added.

5. The automobile placard of claim 1, wherein said automobile-mirror-hanger-hook includes an arcuate bend.

6. The automobile placard of claim 1, wherein said automobile-mirror-hanger-hook is configured to be removably-coupleable with a mirror-mount-stem of an automobile interior rear view mirror.

7. The automobile placard of claim 1, wherein said flip-latch of said automobile-mirror-hanger-hook is configured to flex into an open configuration when placing said automobile placard about said mirror-mount-stem.

8. The automobile placard of claim 7, wherein said flip-latch of said automobile-mirror-hanger-hook is further configured to latch onto to said mirror-mount-stem when in the closed configuration.

9. The automobile placard of claim 1, wherein said erasable surface is configured to be eraseably written on by an erasable marker.

10. The automobile placard of claim 1, wherein said erasable surface is configured to be eraseably written on by a grease pencil.

11. The automobile placard of claim 1, wherein said erasable surface is configured to be eraseably written on by a graphite pencil.

12. The automobile placard of claim 1, wherein said permanent indicia further guides the user to add said variable information to said front side of said automobile placard.

13. The automobile placard of claim 1, wherein said backside is structured to be eraseably written on with alterable information.

14. The automobile placard of claim 6, wherein said automobile-mirror-hanger-hook is at least partially made of durable plastic suitable for extended periods of UV exposure.

15. The automobile placard of claim 1, wherein said placard has a thickness between 1 mm and 5 mm.

16. The automobile placard of claim 15, wherein said placard is at least partially made of flexible durable plastic suitable for extended periods of UV exposure.

17. The automobile placard of claim 15, wherein said placard is at least partially made of fade-resistant colored materials suitable for an environment with extended periods of UV exposure.

18. A placard for displaying information on an automobile, the placard comprising:
a front side including an indicium printed with permanent indicia describing one or more fillable fields, and further including an erasable surface adapted to be repeatedly written on and erased;
a back side;
a substantially rectangular perimeter having a bottom end and a top end; and
an automobile-mirror-hanger-hook attached to the top end, the automobile-mirror-hanger-hook having an open configuration and closed configuration;
wherein said automobile-mirror-hanger-hook includes a flip-latch configured to be removably-coupleable with a support mirror by flexing into an open configuration when pressed onto the support and latch by springing back; and
wherein said top end has two rounded corners.

19. The placard of claim 18, further comprising a set of instructions, wherein the placard and the set of instructions for the placard are arranged as a kit.

20. A method of using a placard system, the method comprising the steps of:
adding variable information to a front side of a placard using a permanent indicia as a guide;
opening a hanger-hook flip-latch that is attached to the placard by pushing the flip-latch against a support member;
closing the flip-latch of the hanger-hook around the support member by releasing the placard;
removing said placard by opening the flip-latch by applying a tension to the flip-latch; and
erasing said variable information.
